(19) United States
(12) Patent Application Publication
(10) Pub. No.: US 2006/0016499 A1
(43) Pub. Date: Jan. 26, 2006

(54) Flexible, kink resistant, fluid transfer hose construction

(76) Inventors: Ralph T. Blanchard, Feeding Hills, MA (US); Michael Fonfara, Chicopee, MA (US); Richard L. Rabe, LaCrosse, WI (US); Fernando A. Cuccioli, Midland, MI (US)

Correspondence Address: HOLLAND & BONZAGNI, P.C., 171 DWIGHT ROAD, SUITE 302, LONGMEADOW, MA, 01106-1700, US

(21) Appl. No.: 10/527,045

(22) PCT Filed: Sep. 5, 2003
(86) PCT No.: PCT/US03/27867

§ 371 Date: Aug. 23, 2005

(51) Int. Cl. F16L 57/00; F16L 11/04; C08L 83/00; C08L 77/00; B32B 37/00

(52) U.S. Cl. 138/110; 525/474; 525/540; 428/36.91

(57) ABSTRACT

A flexible, kink resistant, fluid transfer hose construction that employs a flexible and abrasion-resistant protective jacket is provided. The protective jacket demonstrates the necessary mechanical properties to be included under a crimped sleeve or collar of a hose coupling, thereby increasing the useful life of the hose by, for example, preventing damaging chemicals from accessing underlying layers at each end of the hose construction.

### RELATED APPLICATION

This application claims priority from U.S. Provisional Patent Application Ser. No. 60/409,708, filed Sep. 9, 2002.

### TECHNICAL FIELD

The present invention relates to a flexible, kink resistant, fluid transfer hose construction that employs a flexible and abrasion-resistant protective jacket that demonstrates the necessary mechanical properties to be included under a crimped sleeve or collar of a hose coupling.

### BACKGROUND ART

Hose assemblies for conveying corrosive or aggressive materials are known. For automotive applications, these assemblies are typically routed through crowded engine compartments that reach temperatures ranging from −40° C. to 175° C. and carry fluids such as fuel and brake fluid that have the potential to chemically erode, swell or otherwise degrade the interior of the hose assemblies. Thus, these assemblies have to be resistant to physical, thermal and chemical degradation. Moreover, these hose assemblies have to resist kinking during installation, use and service.

Hose assemblies that include an inner fluoropolymer (e.g., polytetrafluoroethylene (PTFE)) tube or cylindrical member surrounded by a loosely to tightly wound metallic (e.g., stainless steel) braid have been found to provide these necessary physical characteristics.

Abrasion-resistant materials have been used on these prior art braided hose assemblies as outer protective jackets for the purpose of protecting the metallic braid from e.g. corrosion and road hazards, and for the purpose of preventing the metallic braid from damaging or physically eroding nearby components in the engine compartment.

Unfortunately, the jacket materials used on these braided hose assemblies either do not demonstrate the necessary mechanical properties to include the material under the crimped sleeve or collar of a hose coupling or the jacketed hose assemblies fail to demonstrate the necessary flexibility and kink resistance.

By way of example, U.S. Pat. No. 5,622,394 to Soles et al. describes a flexible hose assembly comprising a plastic outer coating 54 where it is necessary to strip the coating 54 back from an end of the hose 32 prior to attaching an end fitting. As will be readily appreciated, abrasive tools used to strip the plastic coating 54 back from this area may damage the metallic braid. Moreover, such an operation is time-consuming and serves to expose the metallic braid to damaging chemicals at each end of the hose.

By way of further example, hose assemblies jacketed with HYTREL® polyester elastomers have been subjectively evaluated by automotive suppliers as being too stiff, while hose assemblies jacketed with DYNEON™ THV melt-processable fluoroelastomers, which are also stiff, are known to demonstrate poor kink resistance and to have a tendency to buckle, leading vehicle inspectors to believe that rupture of the hose is imminent.

A need therefore exists for a fluid transfer hose construction that is flexible and kink resistant and that employs a flexible and abrasion resistant protective jacket that demonstrates the necessary mechanical properties to be included under a crimped collar of a hose coupling.

It is therefore a primary object of the present invention to provide such a hose construction.

It is a more particular object to provide an abrasion resistant thermoplastic elastomeric material having improved flexibility for use as a protective jacket for such hose constructions.

It is another more particular object to provide a flexible, kink resistant, fluid transfer hose construction and assembly that are jacketed with such a thermoplastic elastomeric material.

### SUMMARY OF THE INVENTION

The present invention therefore provides a flexible and abrasion resistant thermoplastic elastomeric material, which is suitable for use as a protective jacket on flexible, kink resistant, fluid transfer hose constructions, wherein the thermoplastic elastomeric material comprises a reaction product of:
(a) at least one Theologically stable polyamide resin having a melting point or glass transition temperature of from about 25° C. to about 275° C.;
(b) a diorganopolysiloxane gum having a plasticity of at least 30 and having an average of at least two alkenyl groups in its molecule, wherein the weight ratio of the diorganopolysiloxane gum to the polyamide resin(s) ranges from about 40:60 to about 75:25;
(c) a compatibilizer selected from the group of:
   i. a coupling agent having a molecular weight of less than 800 which contains at least two groups independently selected from ethylenically unsaturated group, epoxy, anhydride, silanol, carboxyl, oxazoline or alkoxy having 1 to 20 carbon atoms, in its molecule,
   ii. a functional diorganopolysiloxane having at least one group selected from epoxy, anhydride, silanol, carboxyl, amine, oxazoline or alkoxy having 1 to 20 carbon atoms, in its molecule, or
   iii. a copolymer comprising at least one diorganopolysiloxane block and at least one block selected from polyamide, polyether, polyurethane, polyurea, polycarbonate or polyacrylate;
(d) an organohydrido silicon compound which contains an average of at least two silicon-bonded hydrogen groups in its molecule; and
(e) a hydrosilation catalyst.

The present invention further provides a method for preparing the thermoplastic elastomeric material described above, wherein the method comprises: mixing components (a) through (e), wherein components (d) and (e) are present in an amount sufficient to cure component (b); and then curing component (b).

The present invention also provides a flexible, kink resistant, fluid transfer hose construction comprising:
(1) a heat and chemically resistant inner tube; and
(2) a flexible and abrasion-resistant protective jacket formed on the inner tube, wherein the hose construction demonstrates a flexural modulus at 23° C. (as measured by ASTM D790) of less than or equal to about 330 megapascals (MPa).

The present invention further provides a hose assembly comprising the above-referenced flexible, kink resistant, fluid transfer hose construction and coupling means.

Other features and advantages of the invention will be apparent to one of ordinary skill from the following detailed description and accompanying drawings.

Unless otherwise defined, all technical and scientific terms used herein have the same meaning as commonly understood by one of ordinary skill in the art to which this invention belongs. All publications, patent applications, patents and other references mentioned herein are incorporated by reference in their entirety. In case of conflict, the present specification, including definitions, will control. In addition, the materials, methods, and examples are illustrative only and not intended to be limiting.

### BRIEF DESCRIPTION OF THE DRAWINGS

Particular features of the disclosed invention are illustrated by reference to the accompanying drawings in which:

FIG. 1 is a latitudinal cross-sectional view of the hose construction of the present invention;

FIGS. 2 to 4 are latitudinal cross-sectional views of preferred embodiments of the inventive hose construction; and

FIG. 5 is a longitudinal cross-sectional view of the hose assembly of the present invention.

### BEST MODE FOR CARRYING OUT THE INVENTION

The hose construction of the present invention, which demonstrates a flexural modulus at 23° C. (as measured by ASTM D790) of less than or equal to about 330 MPa (preferably, less than or equal to about 320 MPa, and more preferably, from about 200 to about 320 MPa), may be used in a wide variety of applications. For example, in addition to static automotive applications (e.g., as a flexible component in a rigid brake line system) and dynamic automotive applications (e.g., as a “jounce” or flexible hose mounted to a wheel on a front steering axle), the inventive hose construction may be used in freezer, refrigerator and air-conditioning systems and in the manufacture of semi-conductors.

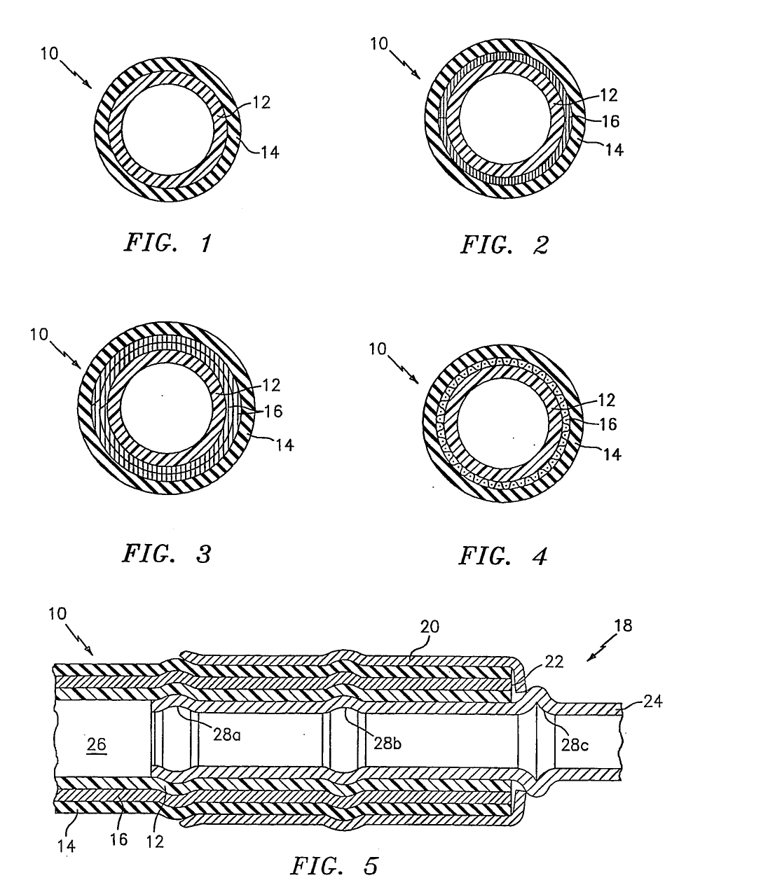

Referring now to the drawings in detail, the flexible, kink resistant, fluid transfer hose construction of the present invention is shown generally at 10. As best shown in FIG. 1, the inventive hose construction 10 is basically comprised of a heat and chemically resistant inner tube 12 and a flexible and abrasion-resistant protective jacket 14 formed on inner tube 12.

The heat and chemically resistant inner tube 12 of hose construction 10 can effectively accommodate a wide variety of aggressive or degrading fluids, is such as brake fluids, hydraulic oils and fuels. Inner tube 12, which preferably has a wall thickness ranging from about 0.13 millimeters (mm) to about 1.9 mm and an inner diameter ranging from about 2.5 mm to about 50.8 mm, can be made of any polymeric material that is extrudable or moldable and that has a compressive strength (as measured by ASTM D695) of from about 3.4 MPa to about 310 MPa. Such materials include fluorocarbon polymers, polyamides, polyethylene resins, polyesters, polyimides, polypropylene, polyvinylchloride, silicones, and mixtures thereof. Preferably, inner tube 12 is made of a fluorocarbon polymer such as PTFE, copolymers of tetrafluoroethylene and hexafluoropropylene (FEP), perfluroalkoxyl resins (PFA) and polymers of ethylene-tetrafluoroethylene (ETFE). PTFE, FEP and PFA are sold by E.I. DuPont De Nemours, Inc., Wilmington, Del., under the trademark TEFLON. ETFE is also sold by DuPont under the trademark TEFZEL. More preferably, inner tube 12 is made of PTFE.

The flexible and abrasion-resistant protective jacket 14 formed on inner tube 12 is prepared from a thermoplastic elastomeric material and demonstrates the necessary mechanical properties to be included under a crimped sleeve or collar of a hose coupling.

As will be readily appreciated, the ability to include protective jacket 14 in the crimp zone without promoting buckling along the length of the hose, increases the useful life of the hose by eliminating false indicators of imminent hose failures and by preventing damaging chemicals from accessing inner tube 12 or a reinforcing or barrier layer at each end of the hose. In addition, the cost of manufacture is decreased as a result of the elimination of the stripping operation.

In a preferred embodiment, the protective jacket 14 is a flame resistant, thermoplastic elastomeric material formed from optionally compatiblized polyamide (e.g., nylon) resins. Thermoplastic elastomeric materials formed from polyamide resins, which are suitable for use in the present invention, are described in U.S. Pat. No. 6,362,287 B1 to Chorvath et al., while thermoplastic elastomeric materials formed from compatibilized polyamide resins, which are also suitable for use in the present invention, are described in U.S. Pat. No. 6,362,288 B1 to Brewer et al.

In a more preferred embodiment, the thermoplastic elastomeric material used to form protective jacket 14 is a reaction product of:
(a) at least one rheologically stable polyamide resin having a melting point or glass transition temperature of from about 25° C. to about 275° C.;
(b) a diorganopolysiloxane gum having a plasticity of at least 30 and having an average of at least two alkenyl groups in its molecule, wherein the weight ratio of the diorganopolysiloxane gum to the polyamide resin(s) ranges from about 40:60 to about 75:25;
(c) a compatibilizer selected from the group of:
   i. a coupling agent having a molecular weight of less than 800 which contains at least two groups independently selected from ethylenically unsaturated group, epoxy, anhydride, silanol, carboxyl, oxazoline or alkoxy having 1 to 20 carbon atoms, in its molecule,
   ii. a functional diorganopolysiloxane having at least one group selected from epoxy, anhydride, silanol, carboxyl, amine, oxazoline or alkoxy having 1 to 20 carbon atoms, in its molecule, or
   iii. a copolymer comprising at least one diorganopolysiloxane block and at least one block selected from polyamide, polyether, polyurethane, polyurea, polycarbonate or polyacrylate;
(d) an organohydrido silicon compound which contains an average of at least two silicon-bonded hydrogen groups in its molecule; and
(e) a hydrosilation catalyst.

In yet a more preferred embodiment, the thermoplastic elastomeric material is a reaction product of.
(a) from about 30 to about 60 parts by weight, based on the total weight of the thermoplastic elastomeric material, of at least one rheologically stable polyamide resin having a melting point or glass transition temperature of from about 25° C. to about 275° C.;
(b) from about 40 to about 70 parts by weight, based on the total weight of the thermoplastic elastomeric material, of a diorganopolysiloxane gum having a plasticity of at least 30 and having an average of at least two alkenyl groups in its molecule, wherein the weight ratio of the diorganopolysiloxane gum to the polyamide resin(s) ranges from about 40:60 to about 70:30;
(c) from about 0.5 to about 5 parts by weight, per 100 parts of the polyamide, of a compatibilizer selected from the group of
   i. a coupling agent having a molecular weight of less than 800 which contains at least two groups independently selected from ethylenically unsaturated group, epoxy, anhydride, silanol, carboxyl, oxazoline or alkoxy having 1 to 20 carbon atoms, in its molecule,
   ii. a functional diorganopolysiloxane having at least one group selected from epoxy, anhydride, silanol, carboxyl, amine, oxazoline or alkoxy having 1 to 20 carbon atoms, in its molecule, or
   iii. a copolymer comprising at least one diorganopolysiloxane block and at least one block selected from polyamide, polyether, polyurethane, polyurea, polycarbonate or polyacrylate;
(d) an organohydrido silicon crosslinking compound in an amount sufficient to provide from about 3 to about 30 moles of SiH groups per mole of Si-alkenyl groups in component (b), wherein the organohydrido silicon crosslinking compound contains an average of at least two silicon-bonded hydrogen groups in its molecule; and
(e) a hydrosilation catalyst in an amount sufficient to provide from about 0.75 to about 100 parts per million (ppm) of metal ions based on the total weight of the thermoplastic elastomeric material.

In a most preferred embodiment, the material used to form protective jacket 14 is a reaction product of:
(a) from about 30 to about 60 parts by weight, based on the total weight of the thermoplastic elastomeric material, of a mixture of polyamides comprising (I) from about 65 to about 75 parts by weight, based on the total weight of the polyamide mixture, of a nylon 6 resin; and (it) from about 25 to about 35 parts by weight, based on the total weight of the polyamide mixture, of a nylon 6/12 resin;
(b) from about 40 to about 70 parts by weight, based on the total weight of the thermoplastic elastomeric material, of a polydimethylsiloxane material;
(c) from about 0.5 to about 5 parts by weight, based on the total weight of the polyamide mixture, of an epoxy functional silicone fluid compatibilizer;
(d) an organohydrido silicon crosslinking compound in an amount sufficient to provide from about 3 to about 30 moles of SiH groups per mole of Si-alkenyl groups in component (b);
(e) a hydrosilation catalyst in an amount sufficient to provide from about 0.75 to about 100 ppm of metal ions based on the total weight of the thermoplastic elastomeric material;
(e) from about 0.4 to about 1.5 parts by weight, based on the total weight of the thermoplastic elastomeric material, of a silicone fluid;
(g) from about 0.475 to about 0.525 parts by weight, based on the total weight of the thermoplastic elastomeric material, of an antioxidant; and
(h) from about 0.4 to about 1.6 parts by weight, based on the total weight of the thermoplastic elastomeric material, of a colorant.

Exemplary materials for use in this most preferred embodiment are identified below:
nylon 6 resin—available from Custom Resins, P.O. Box 46, Henderson, Ky. 42420, under the trade designation NYLENE® NX3024F (Dry);
nylon 6/12 resin—available from EMS-CHEMIE (North America) Inc., 2060 Corporate Way, P.O. Box 1717, Sumter, S.C. 29151-1717 USA, under the trade designation GRILON CR 6S;
polydimethylsiloxane material—available from Dow Corning Corporation, P.O. Box 0994, Midland, Mich. 48686-0994, under the trade designation SILASTIC® GP-30 silicone rubber;
epoxy functional silicone fluid—available from Genesee Polymers Corporation, G-5251 Fenton Road, Flint, Mich. 48507-4036, under the trade designation GP-32-SILICONE FLUID;
organohydrido silicon crosslinking compound—available from Dow Corning Corporation under the trade designation SYL-OFF® 7678;
hydrosilation catalyst—available from Dow Corning Corporation under the trade designation SYL-OFF® 4000;
silicone fluid—available from Dow Corning Corporation under the trade designation Dow Corning 200® Fluid, 1000 CST;
antioxidant—available from Great Lakes Chemical Corporation, 1-T Great Lakes Blvd. Hwy 52, N.W., West Lafayette, Ind. 47906-0200, under the trade designation LOWINOX CA22; and
colorant—available from Americhem, Inc., 225 Broadway East, Cuyahoga Falls, Ohio 44221, under the trade designation 16909-F25 BLACK.

The thermoplastic elastomeric material used to form protective jacket 14 may be prepared in accordance with the teachings of U.S. Pat. No. 6,362,288 B1. In a preferred embodiment, the thermoplastic elastomeric material is prepared by compounding the component mixture in a twin-screw extruder, where components (d) and (e) are present in the mixture in amounts sufficient to cure component (b), pelletzing the compounded mixture, and then vacuum drying the pellets overnight at 80° C. The pellets may then be melt-blended and extruded over inner tube 12 and cured to form protective jacket 14. It is noted that protective jacket 14, upon curing will not adhere to inner tube 12.

The protective jacket 14 preferably has a wall thickness ranging from about 0.05 mm to about 2.54 mm and an inner diameter ranging from about 3.2 mm to about 19.0 mm or greater.

In a more preferred embodiment of the present invention, the flexible, kink resistant, fluid transfer hose construction 10 comprises: (1) a PTFE inner tube 12; and (2) a flexible and abrasion-resistant protective jacket 14 that comprises a flame resistant, thermoplastic elastomeric material formed from one or more compatiblized polyamide resins.

Hose construction 10 of the present invention may further comprise at least one reinforcing or barrier layer 16 prepared from reinforcing or barrier materials loosely or tightly braided, woven or wound about the exterior of inner tube 12. Materials suitable for use in layer 16 include metal (e.g., carbon, carbon steel, copper, brass, stainless steel and alloys thereof) and non-metal (e.g., polyester, nylon, aramid) reinforcing or barrier materials.

In two such embodiments, which are best shown in FIGS. 2 and 3, layer 16 is a barrier layer comprising one or more metal layers laminated to the outer surface of inner tube 12. The metal layer(s), which serves to reduce permeation of e.g. hydrocarbons through hose construction 10, is formed by wrapping a metal strip (e.g., a conversion coated aluminum strip) around the inner tube 12 to form either a single-walled or double-walled metal structure.

Preferably, barrier layer 16 is a single-walled aluminum structure prepared in accordance with the methods described in U.S. Pat. No. 5,40,334 to O'Melia et al. and U.S. Pat. No. 5,531,841 to O'Melia et al.

More preferably, barrier layer 16 is prepared by dispersing a fluoropolymer in a chromate conversion coating and then by applying the resulting mixture to a strip of aluminum foil having a thickness of from about 0.025 to about 2.500 mm. The fluoropolymer/conversion coated aluminum strip is then either axially or helically wrapped around a preexisting fluoropolymer tube. The resulting construction is then heated to a temperature of about 350° C. for approximately 3 to 5 minutes. In a more preferred embodiment, the axially or helically wrapped aluminum foil strip is overlapped (e.g., 15 to 50% overlap) to cover any gaps or leak paths in the aluminum foil layer thereby further reducing permeation through hose construction 10.

In another embodiment (not shown), layer 16 is a reinforcing layer comprising an interwoven braid or a spiral winding of one or more synthetic fibrous materials. Such fibrous materials include, but are not limited to, aramid fibers, polyethylene fibers, poly(p-phenylene-2,6-benzobisoxazole) fibers, polyvinyl alcohol fibers, and mixtures thereof. Aramid yarns or fibers are sold by E. I. du Pont de Nemours and Company, 1007 Market Street, Wilmington, Del. 19898, under the trade designation KEVLAR synthetic aramid fiber, and by Teijin Shoji (USA), 42 W 39^{th} St. Fl. 6, New York, N.Y. 10018-3809, USA, under the trade designation TECHNORA para-aramid fiber. Polyethylene fibers are available from Honeywell International Inc., 101 Columbia Road, Morristown, N.J. 07962, under the trade designation SPECTRA polyethylene fiber, and also from Toyobo Co., Ltd., DYNEEMA Department, 2-8, Dojimahama 2-chome, Kita-Ku, Osaka 530-8230, JAPAN, under the trade designation DYNEEMA SK60 polyethylene fiber. Poly(p-phenylene-2,6-benzobisoxazole) or POB fibers are also sold by Toyobo Co., Ltd., ZYLON Department, under the trade designation ZYLON PBO fibers, while polyvinyl alcohol fibers are sold by Kuraray America, Inc., 101 East 52^{nd} Street, 26^{th} floor, New York, N.Y. 10022, under the trade designation KURALON polyvinyl alcohol fibers.

In yet another embodiment, which is best shown in FIG. 4, layer 16 is a reinforcing layer comprising an interwoven braid or a spiral winding of a metal (e.g., stainless steel) wire.

Reinforcing or barrier layer 16 preferably has a wall thickness ranging from about 0.025 mm to about 2.000 mm and an inner diameter ranging from about 3.2 mm to about 100.0 mm.

Hose construction 10 of the present invention may include additional layers, which overlie the exterior surface of protective jacket 14. For example, in applications requiring higher pressure ratings, hose construction 10 may further comprise one or more additional reinforcing or barrier layers and, optionally, one or more additional flexible and abrasion-resistant protective jackets.

In a preferred process for preparing hose construction 10, a polymeric material is extruded to form an inner tube 12 having a wall thickness of from about 0.13 mm to about 1.9 mm and an inner diameter of from about 2.5 mm to about 50.8 mm. A reinforcing or barrier material may then be braided, weaved or wound about the exterior of inner tube 12 to form reinforcing or barrier layer 16. The pelletized thermoplastic elastomeric material is then melt-blended and extruded onto either the inner tube 12 or the reinforcing or barrier layer 16 and is then cross-linked using known techniques which include chemical and radiation cross-linking methods.

Referring now to FIG. 5, a preferred embodiment of the flexible, kink resistant, fluid transfer hose assembly of the present invention is shown generally at 18. In a preferred process for preparing this embodiment of hose assembly 18, a crimp collar 20 is positioned on a cut end 22 of hose construction 10 followed by the insertion of a tube-like fitting 24 into the interior 26 of the inner tube 12. Tube-like fitting 24 may be mechanically formed to produce beads or upsets 28a, 28b, 28c, along its length either before or after the fitting 24 is inserted into inner tube 12. As will be readily appreciated, beads or upsets 28a, 28b, serve to provide resistance to tube movement under internal pressure to the hose 10, while bead or upset 28c serves as a “stop bead” to ensure the proper depth of insertion of fitting 24 into inner tube 12. The crimp collar 20 and fitting 24 are then mechanically attached to hose 10 by applying sufficient force to deform the collar 20 around the hose 10 and to effect a seal between the outside diameter of the fitting 24 and the inside diameter of the inner tube 12. More specifically, between from about 27.6 to about 450 MPa of mechanical pressure is applied to collar 20 via a mechanical swage or crimp process which serves to apply pressure through the collar 20 to the intermediate layer(s) and eventually to the inner tube 12 causing the outside diameter of the fitting 24 to seal against the inside diameter of inner tube 12. The resulting connection has sufficient strength to withstand severe torsional stresses that can result during handling, installation and service and provides a seal to substantially predude the undesired and gradual escape of fluids over the lifetime of the assembly. As will be readily apparent to those skilled in the art, the length of crimp collar 20 and fitting 24, as well as, the number of beads or upsets 28, may be reduced for lower pressure hose applications.

The hose assembly of the present invention, which comprises hose construction 10 and coupling means, demonstrates a balance of physical is properties. For example, the inventive hose assembly satisfies the minimum requirements set by the Automotive Industry, namely—(1) tensile pull strength—the ability to withstand a pull of at least about 1445 Newtons (N) (325 pounds), preferably, at least about 5382 N (1210 pounds), and more preferably, at least about 5471 N (1230 pounds), without separation of the hose from its end fittings (U.S. Department of Transportation (DOT) Motor Vehicle Safety Specification (MVSS) § 571.106 S5.3.4), (2) burst strength—the ability to withstand water pressures ranging from 27.6 to 34.5 MPa (4,000 to 5,000 psi) without rupture (U.S. DOT MVSS § 571.106 S5.3.2), and (3) impulse resistance—the ability to withstand at least 150 hot impulse cycles with a brake fluid heated to a temperature of 143° C. (295° F.). For this test, pressure is applied to the fluid and the hose at a level of 11 MPa (1600 psi) for one minute, the pressure is then released to substantially ambient pressure for one minute and the cycle repeated (Society of Automotive Engineers (SAE) J1401).

Preliminary testing of aramid-reinforced PTFE hose assemblies jacketed with either a HYTREL® polyester elastomer, a DYNEON® THV melt-processable fluoroelastomer or the silicone elastomeric material of the present invention has shown, as set forth below, that the hose assembly of the present invention demonstrates increased flexibility and improved tensile pull strength over these prior art hose assemblies.

| | | Tensile Pull Strength² |
|---|---|---|
| Jacket Material | Flexural Modulus¹ | (Newtons) |
| DYNEON ® THV | 490 MPa (71,000 psi) | 5337 (1,200 pounds) |
| fluoroelastomer | | |
| HYTREL ® polyester | 331 MPa (48,000 psi) | 4537 (1,020 pounds) |
| elastomer | | |
| Inventive Silicone | 317 MPa (46,000 psi) | 5471 (1,230 pounds) |
| Elastomeric Material | | |

¹ASTM D790 (23° C.)
²U.S. DOT MVSS § 571.106 S5.3.4

While various embodiments of the present invention have been described above, it should be understood that they have been presented by way of example only, and not limitation. Thus, the breadth and scope of the present invention should not be limited by any of the exemplary embodiments.

Having thus described the invention, what is claimed is:

1. A method for preparing a protective jacket for use on flexible, kink resistant, fluid transfer hose constructions, wherein the method comprises preparing the protective jacket using a thermoplastic elastomeric material that comprises a reaction product of:
(a) at least one rheologically stable polyamide resin having a melting point or glass transition temperature of from about 25° C. to about 275° C.;
(b) a diorganopolysiloxane gum having a plasticity of at least 30 and having an average of at least two alkenyl groups in its molecule, wherein the weight ratio of the diorganopolysiloxane gum to the polyamide resin(s) ranges from about 40:60 to about 75:25;
(c) a compatibilizer selected from the group of:
i. a coupling agent having a molecular weight of less than 800 which contains at least two groups independently selected from ethylenically unsaturated group, epoxy, anhydride, silanol, carboxyl, oxazoline or alkoxy having 1 to 20 carbon atoms, in its molecule,
ii. a functional diorganopolysiloxane having at least one group selected from epoxy, anhydride, silanol, carboxyl, amine, oxazoline or alkoxy having 1 to 20 carbon atoms, in its molecule, or
iii. a copolymer comprising at least one diorganopolysiloxane block and at least one block selected from polyamide, polyether, polyurethane, polyurea, polycarbonate or polyacrylate;
(d) an organohydrido silicon compound which contains an average of at least two silicon-bonded hydrogen groups in its molecule; and
(e) a hydrosilation catalyst.

2. The method of claim 1, wherein the Theologically stable polyamide resin(s) of the thermoplastic elastomeric material is present in an amount ranging from about 30 to about 60 parts by weight, based on the total weight of the thermoplastic elastomeric material.

3. The method of claim 2, wherein the Theologically stable polyamide resin(s) is a mixture of polyamides comprising (i) from about 65 to about 75 parts by weight, based on the total weight of the polyamide mixture, of a nylon 6 resin; and (ii) from about 35 to about 25 parts by weight, based on the total weight of the polyamide mixture, of a nylon 6/12 resin.

4. The method of claim 1, wherein the diorganopolysiloxane gum of the thermoplastic elastomeric material is present in an amount ranging from about 40 to about 70 parts by weight, based on the total weight of the thermoplastic elastomeric material, and wherein the weight ratio of the diorganopolysiloxane gum to the polyamide resin(s) ranges from about 40:60 to about 70:30.

5. The method of claim 4, wherein the diorganopolysiloxane gum is a polydimethysiloxane material.

6. The method of claim 1, wherein the compatibilizer of the thermoplastic elastomeric material is present in an amount ranging from about 0.5 to about 5 parts by weight, per 100 parts of the polyamide resin(s).

7. The method of claim 6, wherein the compatibilizer is an epoxy functional silicone fluid compatibilizer.

8. The method of claim 1, wherein the thermoplastic elastomeric material further comprises one or more silicone fluids, antioxidants and colorants.

9. The method of claim 1, wherein the thermoplastic elastomeric material is cross-linked.

10. A flexible, kink resistant, fluid transfer hose construction comprising:
(a) a heat and chemically resistant inner tube; and
(b) a flexible and abrasion-resistant protective jacket formed on the inner tube, wherein the hose construction demonstrates a flexural modulus at 23° C. (as measured by ASTM D790) of less than or equal to about 330 megapascals.

11. The hose construction of claim 10, which demonstrates a flexural modulus at 23° C. (as measured by ASTM D790) of less than or equal to about 320 megapascals.

12. The hose construction of claim 11, which demonstrates a flexural modulus at 23° C. (as measured by ASTM D790) of from about 200 to about 320 megapascals.

13. The hose construction of claim 10, wherein the heat and chemically resistant inner tube is prepared from an extrudable or moldable polymeric material that has a compressive strength (as measured by ASTM D695) of from about 3.4 to about 310 megapascals.

14. The hose construction of claim 13, wherein the polymeric material is selected from the group of fluorocarbon polymers, polyamides, polyethylene resins, polyesters, polyimides, polypropylene, polyvinylchloride, silicones, and mixtures thereof.

15. The hose construction of claim 14, wherein the polymeric material is a fluorocarbon polymer selected from the group of polytetrafluoroethylene, copolymers of tetrafluoroethylene and hexafluoropropylene, perfluoroalkoxyl resins and polymers of ethylene-tetrafluoroethylene.

16. The hose construction of claim 10, wherein the heat and chemically resistant inner tube has a wall thickness ranging from about 0.13 to about 1.9 millimeters, and an inner diameter ranging from about 2.5 to about 50.8 millimeters.

17. The hose construction of claim 10, wherein the flexible and abrasion-resistant protective jacket is prepared from a thermoplastic elastomeric material.

18. The hose construction of claim 17, wherein the thermoplastic elastomeric material is formed from optionally compatibilized polyamide resins.

19. The hose construction of claim 18, wherein the thermoplastic elastomeric material comprises a reaction product of:
(a) at least one rheologically stable polyamide resin having a melting point or glass transition temperature of from about 25° C. to about 275° C.;
(b) a diorganopolysiloxane gum having a plasticity of at least 30 and having an average of at least two alkenyl groups in its molecule, wherein the weight ratio of the diorganopolysiloxane gum to the polyamide resin(s) ranges from about 40:60 to about 75:25;
(c) a compatibilizer selected from the group of
i. a coupling agent having a molecular weight of less than 800 which contains at least two groups independently selected from ethylenically unsaturated group, epoxy, anhydride, silanol, carboxyl, oxazoline or alkoxy having 1 to 20 carbon atoms, in its molecule,
ii. a functional diorganopolysiloxane having at least one group selected from epoxy, anhydride, silanol, carboxyl, amine, oxazoline or alkoxy having 1 to 20 carbon atoms, in its molecule, or
iii. a copolymer comprising at least one diorganopolysiloxane block and at least one block selected from polyamide, polyether, polyurethane, polyurea, polycarbonate or polyacrylate;
(d) an organohydrido silicon compound which contains an average of at least two silicon-bonded hydrogen groups in its molecule; and
(e) a hydrosilation catalyst.

20. The hose construction of claim 19, wherein the Theologically stable polyamide resin(s) is present in the thermoplastic elastomeric material in an amount ranging from about 30 to about 60 parts by weight, based on the total weight of the thermoplastic elastomeric material.

21. The hose construction of claim 20, wherein the Theologically stable polyamide resin(s) is a mixture of polyamides comprising (i) from about 65 to about 75 parts by weight, based on the total weight of the polyamide mixture, of a nylon 6 resin; and (ii) from about 35 to about 25 parts by weight, based on the total weight of the polyamide mixture, of a nylon 6/12 resin.

22. The hose construction of claim 19, wherein the diorganopolysiloxane gum is present in the thermoplastic elastomeric material in an amount ranging from about 40 to about 70 parts by weight, based on the total weight of the thermoplastic elastomeric material, and wherein the weight ratio of the diorganopolysiloxane gum to the polyamide resin(s) ranges from about 40:60 to about 70:30.

23. The hose construction of claim 22, wherein the diorganopolysiloxane gum is a polydimethysiloxane material.

24. The hose construction of claim 19, wherein the compatibilizer is present in the thermoplastic elastomeric material in an amount ranging from about 0.5 to about 5 parts by weight, per 100 parts of the polyamide resin(s).

25. The hose construction of claim 24, wherein the compatibilizer is an epoxy functional silicone fluid compatibilizer.

26. The hose construction of claim 19, wherein the thermoplastic elastomeric material further comprises one or more silicone fluids, antioxidants and colorants.

27. The hose construction of claim 19, wherein the thermoplastic elastomeric material is cross-linked.

28. The hose construction of claim 19, wherein the flexible and abrasion-resistant protective jacket has a wall thickness ranging from about 0.05 to about 2.54 millimeters, and an inner diameter ranging from about 3.2 to about 19.0 millimeters.

29. The hose construction of claim 19, wherein the heat and chemically resistant inner tube is prepared from an extrudable polytetrafluoroethylene material and wherein the flexible and abrasion-resistant protective jacket is prepared from a thermoplastic elastomeric material.

30. The hose construction of claim 19, which further comprises at least one reinforcing or barrier layer.

31. The hose construction of claim 30, wherein the reinforcing or barrier layer comprises one or more metal layers laminated to an outer surface of the inner tube.

32. The hose construction of claim 30, wherein the reinforcing or barrier layer comprises an interwoven braid or spiral winding of one or more synthetic fibrous materials selected from the group of aramid fibers, polyethylene fibers, poly(p-phenylene-2,6-benzobisoxazole) fibers, polyvinyl alcohol fibers, and mixtures thereof.

33. The hose construction of claim 30, wherein the reinforcing or barrier layer comprises an interwoven braid or a spiral winding of a metal wire.

34. The hose construction of claim 30, wherein the reinforcing or barrier layer has a wall thickness ranging from about 0.025 to about 2.000 millimeters, and an inner diameter ranging from about 3.2 to about 100.0 millimeters.

35. A hose assembly comprising:
(a) a flexible, kink resistant, fluid transfer hose construction comprising (i) a heat and chemically resistant inner tube, and (ii) a flexible and abrasion-resistant protective jacket formed on the inner tube, wherein the hose construction demonstrates a flexural modulus at 23° C. (as measured by ASTM D790) of less than or equal to about 330 megapascals; and
(b) coupling means.

36. The hose assembly of claim 35, which demonstrates a tensile pull strength (as measured by U.S. DOT MVSS § 571.106 S5.3.4) of at least about 1445 Newtons.

37. The hose assembly of claim 36, which demonstrates a tensile pull strength (as measured by U.S. DOT MVSS § 571.106 S5.3.4) of at least about 5382 Newtons.

38. The hose assembly of claim 37, which demonstrates a tensile pull strength (as measured by U.S. DOT MVSS § 571.106 S5.3.4) of at least about 5471 Newtons.

39. A flexible and abrasion resistant thermoplastic elastomeric material suitable for use as a protective jacket on flexible, kink resistant, fluid transfer hose constructions, wherein the thermoplastic elastomeric material comprises a reaction product of:
(a) a mixture of polyamides comprising (i) from about 65 to about 75 parts by weight, based on the total weight of the polyamide mixture, of a nylon 6 resin; and (ii) from about 35 to about 25 parts by weight, based on the total weight of the polyamide mixture, of a nylon 6/12 resin;
(b) a diorganopolysiloxane gum having a plasticity of at least 30 and having an average of at least two alkenyl groups in its molecule, wherein the weight ratio of the diorganopolysiloxane gum to the polyamide resin(s) ranges from about 40:60 to about 75:25;
(c) a compatibilizer selected from the group of:
i. a coupling agent having a molecular weight of less than 800 which contains at least two groups independently selected from ethylenically unsaturated group, epoxy, anhydride, silanol, carboxyl, oxazoline or alkoxy having 1 to 20 carbon atoms, in its molecule,
ii. a functional diorganopolysiloxane having at least one group selected from epoxy, anhydride, silanol, carboxyl, amine, oxazoline or alkoxy having 1 to 20 carbon atoms, in its molecule, or
iii. a copolymer comprising at least one diorganopolysiloxane block and at least one block selected from polyamide, polyether, polyurethane, polyurea, polycarbonate or polyacrylate;
(d) an organohydrido silicon compound which contains an average of at least two silicon-bonded hydrogen groups in its molecule; and
(e) a hydrosilation catalyst.

40. A method for preparing a thermoplastic elastomeric material suitable for use as a protective jacket on flexible, kink resistant, fluid transfer hose constructions, which comprises:
(I) mixing
(a) a mixture of polyamides comprising (i) from about 65 to about 75 parts by weight, based on the total weight of the polyamide mixture, of a nylon 6 resin; and (ii) from about 35 to about 25 parts by weight, based on the total weight of the polyamide mixture, of a nylon 6/12 resin;
(b) a diorganopolysiloxane gum having a plasticity of at least 30 and having an average of at least two alkenyl groups in its molecule, wherein the weight ratio of the diorganopolysiloxane gum to the polyamide resin(s) ranges from about 40:60 to about 75:25;
(c) a compatibilizer selected from the group of:
i. a coupling agent having a molecular weight of less than 800 which contains at least two groups independently selected from ethylenically unsaturated group, epoxy, anhydride, silanol, carboxyl, oxazoline or alkoxy having 1 to 20 carbon atoms, in its molecule,
ii. a functional diorganopolysiloxane having at least one group selected from epoxy, anhydride, silanol, carboxyl, amine, oxazoline or alkoxy having 1 to 20 carbon atoms, in its molecule, or
iii. a copolymer comprising at least one diorganopolysiloxane block and at least one block selected from polyamide, polyether, polyurethane, polyurea, polycarbonate or polyacrylate;
(d) an organohydrido silicon compound which contains an average of at least two silicon-bonded hydrogen groups in its molecule; and
(e) a hydrosilation catalyst, components (d) and (e) being present in an amount sufficient to cure component (b); and.
(II) curing component (b).
